(19) United States
(12) Patent Application Publication
(10) Pub. No.: US 2015/0066713 A1
(43) Pub. Date: Mar. 5, 2015

(54) ENTROPIC LINK FILTER FOR AUTOMATIC NETWORK GENERATION

(71) Applicant: Capital One Financial Corporation, McLean, VA (US)

(72) Inventors: Pierrick Burgain, Richmond, VA (US); William A. Hodges, Mechanicsville, VA (US)

(21) Appl. No.: 14/476,024

(22) Filed: Sep. 3, 2014

Related U.S. Application Data
(60) Provisional application No. 61/873,502, filed on Sep. 4, 2013.

(51) Int. Cl. G06Q 40/00

(52) U.S. Cl. CPC G06Q 40/12
USPC 705/30

(57) ABSTRACT

Methods and systems are disclosed for enhancing the information value of data networks. Consistent with disclosed embodiments, in large datasets, automated linking between data entries is facilitated by configuration and application of one or more entropic filters to the data. A computer system separates the data into groups based on the uniqueness of information carried by the data, then determines an entropy value for each group. Based on a predetermined threshold value, the system filters out data entries that have low entropy values and thus low relevance. The system automatically generates prospective links among the filtered data entries, and provides the network of links to another system for further analysis.

### CROSS-REFERENCE TO RELATED APPLICATIONS

This application claims priority under 35 U.S.C. §119 to U.S. Provisional Application No. 61/873,502, filed Sep. 4, 2013, which is expressly incorporated herein by reference in its entirety.

### FIELD

The disclosed embodiments generally relate to enhancing the utility of automatically generated networks for detecting fraud associated with financial service accounts.

### BACKGROUND

Advances in the financial and information technology industries have transformed the way commerce is conducted. For example, with the advent of digital financial management systems, consumers can perform purchase transactions from anywhere at any time using a credit card account or debit card account. This convenience comes at a price, however; fraud and theft have also become more prevalent and difficult to detect.

Organized crime syndicates are responsible for a significant portion of fraud incidents every year. These syndicates have developed sophisticated computer systems that enable them to defraud or impersonate legal account holders and quickly funnel stolen funds or goods beyond the reach of the legal account holders. These crimes cost society billions of dollars each year. Thus, financial service providers must design and deploy equally sophisticated systems to prevent fraud and otherwise identify the perpetrators. The scale of such an operation is staggering. Huge datasets, often full of noise and irrelevant data must be rapidly culled and analyzed, sometimes manually.

Accordingly, a need exists to enhance the ability of investigative entities to quickly and automatically generate relevant links between data entries within networks.

### SUMMARY

Methods and systems described herein enable a computing system to automatically generate links between entries of a dataset, thereby enhancing the ability of investigative entities to quickly and automatically generate relevant links between data entries within networks. In one embodiment, a computing system may receive data associated with a plurality of financial service accounts. Additionally, the computer system may determine a first subset of the data, and determine a plurality of groupings within the first subset based on uniqueness of the data. The computing system may determine an entropy value for each of the plurality of determined groupings, and determine whether one or more of the entropy values associated with the determined groupings are less than a first threshold entropy value for the first subset. Further, the computing system may remove the determined groupings whose entropy values are less than the first threshold entropy value for the first subset from the data. Additionally, the computing system may generate a network of links within the remaining data based on predetermined criteria. Finally, the computing system may generate at least one summary representation of the links.

In another embodiment, a method for automatically generating links between entries of a dataset is disclosed. The method includes receiving data associated with a plurality of financial service accounts. Additionally, the method comprises determining a first subset of the data, and determining a plurality of groupings within the first subset based on uniqueness of the data. The method includes determining, via one or more processors, an entropy value for each of the plurality of determined groupings, and determining, via the one or more processors, whether one or more of the entropy values associated with the determined groupings are less than a first threshold entropy value for the first subset. Further, the method includes removing, via the one or ore processors, the determined groupings whose entropy values are less than the first threshold entropy value for the first subset from the data. The method also includes generating, via the one or more processors, a network of links within the remaining data based on predetermined criteria. Finally, the method includes generating at least one summary representation of the links.

In yet another embodiment, a computing system for detecting fraud is disclosed. The computing system may receive information from a second system associated with automatically generated data networks, the information being received in the form of one or more graphical representations of the automatically generated data networks. Additionally, the computer system may analyze the received information, and perform at least one additional action based off of the analysis, the at least one additional action comprising at least one of investigating an individual based on the received information, applying an additional filter to the received information, or performing an enforcement action.

Additional objects and advantages of the disclosed embodiments will be set forth in part in the description which follows, and in part will be apparent from the description, or may be learned by practice of the embodiments. The objects and advantages of the disclosed embodiments may be realized and attained by the elements and combinations set forth in the claims.

It is to be understood that both the foregoing general description and the following detailed description are exemplary and explanatory only and are not restrictive of the disclosed embodiments, as claimed. For example, the methods relating to the disclosed embodiments may be implemented in system environments outside of the exemplary system environments disclosed herein.

### BRIEF DESCRIPTION OF THE DRAWINGS

The accompanying drawings, which are incorporated in and constitute a part of this specification, illustrate various embodiments and aspects of the disclosed embodiments and, together with the description, serve to explain the principles of the disclosed embodiments. In the drawings:

FIG. 1 illustrates an exemplary system consistent with disclosed embodiments;

FIG. 2 is a flowchart of an exemplary entropic link filtering process consistent with disclosed embodiments;

FIG. 3 is a flowchart of an exemplary filter configuration process consistent with disclosed embodiments;

FIG. 4 is a flowchart of an exemplary filter application process consistent with disclosed embodiments;

FIG. 5 illustrates an exemplary network representation consistent with disclosed embodiments; and

FIG. 6 illustrates an exemplary network representation consistent with disclosed embodiments,

### DETAILED DESCRIPTION

Reference will now be made in detail to disclosed embodiments, examples of which are illustrated in the accompanying drawings. Wherever convenient, the same reference numbers will be used throughout the drawings to refer to the same or like parts.

Generally, disclosed embodiments are directed to systems and methods for enhancing the utility and relevancy of automatically generated networks. For ease of discussion, embodiments may be described in connection with data links and networks generated in order to investigate fraud in association with financial service accounts. It is to be understood, however, that disclosed embodiments are not limited to fraud investigation and may, in fact, be applied to networks generated for any purpose, such as risk assessment, marketing, or quality control. Further, steps or processes disclosed herein are not limited to being performed in the order described, but may be performed in any order, and some steps may be omitted, consistent with the disclosed embodiments.

The features and other aspects and principles of the disclosed embodiments may be implemented in various environments. Such environments and related applications may be specifically constructed for performing the various processes and operations of the disclosed embodiments or they may include a general purpose computer or computing platform selectively activated or reconfigured by program code to provide the necessary functionality. The processes disclosed herein may be implemented by a suitable combination of hardware, software, and/or firmware. For example, the disclosed embodiments may implement general purpose machines that may be configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low level software instructions, such as machine code (e.g., such as that produced by a compiler) and/or high level code that can be executed by a processor using an interpreter.

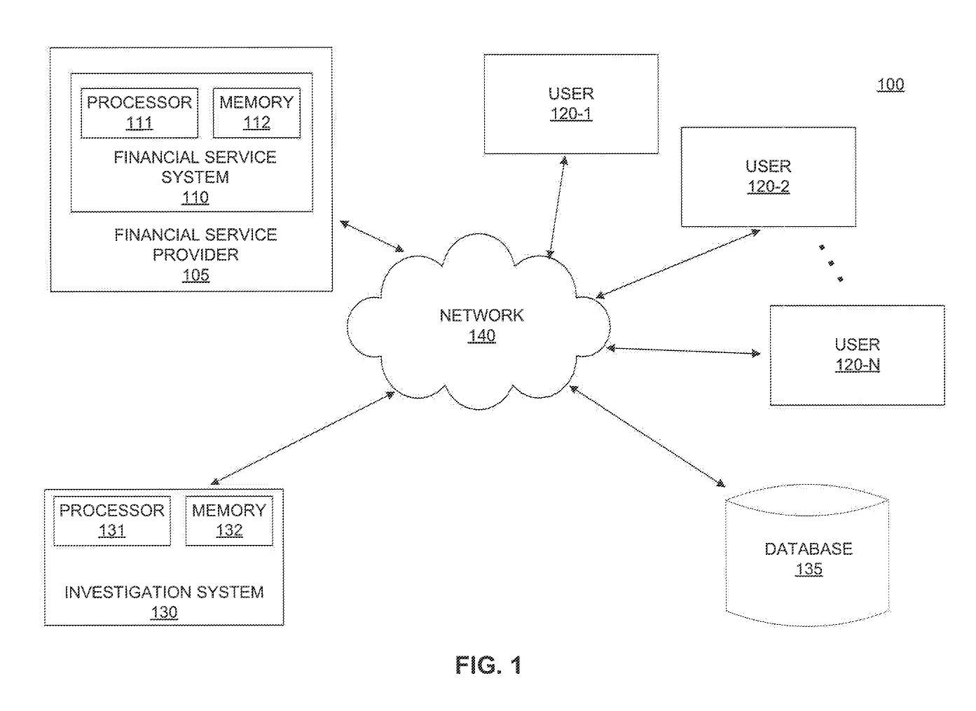

FIG. 1 illustrates an exemplary system 100 consistent with disclosed embodiments. In one aspect, system 100 may include a financial service provider 105, financial service system 110, various users 120-1 through 120-N, investigation system 130, database 135, and network 140.

Financial service provider 105 may be one or more entities that configure, offer, provide, and/or manage financial service accounts, such as credit card accounts, debit card accounts, checking or savings accounts, loyalty accounts, and/or loan accounts. In one aspect, financial service provider 105 may include or be associated with a financial service system 110 configured to perform one or more aspects of the disclosed embodiments. In some embodiments, financial service system 110 may receive and process payments from consumers, such as users 120, relating to one or more financial service accounts provided by financial service provider 105 associated with financial service system 110.

Financial service system 110 may include one or more components that perform processes consistent with the disclosed embodiments. For example, financial service system 110 may include one or more computers (e.g., servers, database systems, etc.) configured to execute software instructions programmed to perform aspects of the disclosed embodiments, such as generating financial service accounts, maintaining accounts, processing information relating to accounts, etc. Consistent with disclosed embodiments, financial service system 110 may include other components and infrastructure that enable it to perform operations, processes, and services consistent with financial service account providers, such as banking operations, credit card operations, loan operations, etc. Consistent with disclosed embodiments, financial service system 110 may be configured to generate, manage, and monitor networks comprised of links between victims and perpetrators of financial fraud.

Users 120-1 through 120-N may represent one or more customers or prospective customers of financial service provider 105. In other embodiments, users 120 may represent victims and/or suspected perpetrators of financial fraud associated with a financial service account associated with financial service provider 105. Users 120 may be an individual, a group of individuals, a business entity, or a group of business entities. Although the description of certain embodiments may refer to an “individual,” the description applies to a group of users or a business entity. In certain aspects, users 120 may be associated with systems (not shown) including one or more computing devices that is associated with (e.g., used by) users 120 to perform computing activities, such as a laptop, desktop computer, tablet device, smart phone, or other handheld or stand-alone devices configured to execute software instructions and communicate with network 140 or other components of system environment 100. For example, users 120 may use a handheld device to communicate with financial service system 110 over the Internet. Reference to users 120 in terms of processes consistent with certain disclosed embodiments may relate to functionalities performed by the users' computing device(s).

Investigation system 130 may include components and infrastructure that enable it to perform operations, processes, and services consistent with investigation and identification of perpetrators of financial fraud, such as analyzing transactions, reviewing computer-generated data networks, and communicating with financial service system 110 or other components. Consistent with disclosed embodiments, investigation system 130 may be configured to receive information associated with automatically generated data networks and utilize the links within the network to identify and investigate instances of financial fraud.

Database 135 may represent one or more storage devices and/or systems that maintain data used by one or more of financial service system 110, users 120, and investigation system 130. Database 135 may include one or more processing components (e.g., storage controller, processor, etc.) that perform various data transfer and storage operations consistent with features consistent with the disclosed embodiments. In some aspects, database 135 may be associated with an independent entity that provides database services for one or more components of system environment 100, consistent with the disclosed embodiments, or for one or more similar component systems in other system environments outside of system environment 100. Database 135 may be an external device accessible by system components within system environment 100 as shown in FIG. 1, or may incorporated as a constituent entity within one or more of the component systems of system environment 100.

Consistent with disclosed embodiments, components of system 100, including financial service system 110 and investigation system 130, may include one or more processors (such as processors 111 or 131) as shown in exemplary form in FIG. 1. The processors may be one or more known processing devices, such as a microprocessor from the Pentium™ family manufactured by Intel™ or the Turion™ family manufactured by AMD™. The processor may include a single core or multiple core processor system that provides the ability to perform parallel processes simultaneously. For example, the processors may be single core processors configured with virtual processing technologies known to those skilled in the art. In certain embodiments, the processors may use logical processors to simultaneously execute and control multiple processes. The processors may implement virtual machine technologies, or other similar known technologies to provide the ability to execute, control, run, manipulate, store, etc. multiple software processes, applications, programs, etc. In some embodiments, the processors may include a multiple-core processor arrangements (e.g., dual or quad core) configured to provide parallel processing functionalities to enable computer components of financial service system 110 and/or investigation system 130 to execute multiple processes simultaneously. Other types of processor arrangements could be implemented that provide for the capabilities disclosed herein. Moreover, the processors may represent one or more servers or other computing devices that are associated with financial service system 110 and/or investigation system 130. For instance, the processors may represent a distributed network of processors configured to operate together over a local or wide area network. Alternatively, the processors may be a processing device configured to execute software instructions that receive and send information, instructions, etc. to/from other processing devices associated with financial service provider 110 or other components of system environment 100. In certain aspects, processors 111 and 131 may be configured to execute software instructions stored in memory to perform one or more processes consistent with disclosed embodiments.

Consistent with disclosed embodiments, components of system 100, including financial service system 110 and investigation system 130, may also include one or more memory devices (such as memories 112 and 132) as shown in exemplary form in FIG. 1. The memory devices may store software instructions that are executed by processors 111 and 131, such as one or more applications, network communication processes, operating system software, software instructions relating to the disclosed embodiments, and any other type of application or software known to be executable by processing devices. The memory devices may be a volatile or non-volatile, magnetic, semiconductor, tape, optical, removable, nonremovable, or other type of storage device or tangible computer-readable medium. The memory devices may be two or more memory devices distributed over a local or wide area network, or may be a single memory device. In certain embodiments, the memory devices may include database systems, such as database storage devices, one or more database processing devices configured to receive instructions to access, process, and send information stored in the storage devices.

In some embodiments, financial service system 110, users 120, investigation system 130, and database 135 may also include one or more additional components (not shown) that provide communications with other components of system environment 100, such as through network 140, or any other suitable communications infrastructure.

Network 140 may be any type of network that facilitates communications and data transfer between components of system environment 100, such as, for example, financial service system 110, users 120, investigation system 130, and database 135. Network 140 may be a Local Area Network (LAN), a Wide Area Network (WAN), such as the Internet, and may be a single network or a combination of networks. Further, network 140 may reflect a single type of network or a combination of different types of networks, such as the Internet and public exchange networks for wireline and/or wireless communications. Network 140 may utilize cloud computing technologies that are familiar in the marketplace. Moreover, any part of network 140 may be implemented through traditional infrastructures or channels of trade, to permit operations associated with financial accounts that are performed manually or in-person by the various entities illustrated in FIG. 1. Network 140 is not limited to the above examples and system 100 may implement any type of network that allows the entities (and others not shown) included in FIG. 1 to exchange data and information.

Although FIG. 1 describes a certain number of entities and processing/computing components within system environment 100, any number or combination of components may be implemented without departing from the scope of the disclosed embodiments. Additionally, financial service system 110 and investigation system 130 are not mutually exclusive. For example, in one disclosed embodiment, financial service system 110 and investigation system 130 may be the same entity or affiliated with the same entity. The entities as described are not limited to their discrete descriptions above. Further, where different components of system environment 100 are combined (e.g., financial service system 110 and investigation system 130, etc.), the computing and processing devices and software executed by these components may be integrated into a local or distributed system.

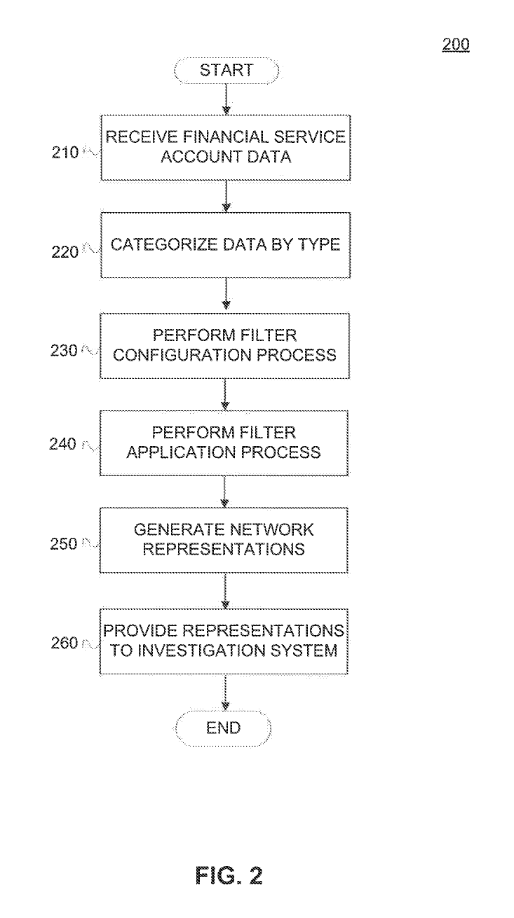

FIG. 2 illustrates an exemplary entropic link filtering process 200, consistent with disclosed embodiments. Entropic link filtering process 200, as well as any or all of the individual steps therein, may be performed by any one or more of financial service system 110 or investigation system 130. For exemplary purposes, FIG. 2 is disclosed as being performed by financial service system 110.

Financial service system 110 may receive data associated with one or more financial service accounts (Step 210). In some embodiments, the associated accounts may be accounts associated with and/or configured by financial service provider 105. Financial service system 110 may receive the data from a variety of sources based on a particular set of facts. Data sources may include, but are not limited to, information relating to internal investigations/fraud data undertaken by financial service system 110, account information, transactional information, IT log files, call center access files, private forums associated with financial service system 110 shared over network 140 used to distribute information associated with comprised data events, public data sources available via network 140, internal emails, employee access logs, vendors (e.g. LexisNexis®, RSA Verid, etc.). For example, if a financial fraud investigation is centered in a particular geographic area, financial service system 110 may receive data relating to all users 120 that are associated with an account configured or managed by financial service provider 105 within that geographic area. In some embodiments, the data may have been previously stored in memory 112 and may be called up from within the memory device. In other embodiments, the data may be received via network 140 from various sources outside of financial service system 110. The data may be received from other components of system environment 100, such as investigation system 130, database 135, or one or more users 120. In some embodiments, if a user 120 is a victim of fraud, financial service system 110 may prompt that user to submit data associated with the user 120, with known associates, and with activities that may lead, for example, investigation system 130 to determine the perpetrator of the fraud. In some embodiments, financial service system 110 may receive the data from the Internet via network 140, including social media networks, websites, weblogs, electronic mail messages, chatrooms, etc. The data may be received in various formats, so long as it is readable by financial service system 110. In some embodiments, the data may be received in a list form. In other embodiments, the data may be received in a database and/or spreadsheet form. In some embodiments processor 111 may convert the received data into a common format readable by financial service system 110 and other components of system environment 100.

Financial service system 110 may be configured to categorize the received data by types (Step 220). In some embodiments, the data categories may be akin to “fields” of data in database 135. Examples of data categories may include, but not be limited to, name, telephone number, date of birth, mailing address, business address, electronic mail address, and Internet Protocol (IP) address, online cookies, account number, check number, card number, branch or ATM identification number or address, social security number, or driver license. In some embodiments, data for a particular entity or individual may be associated with a unique enterprise identification number associated with financial service provider 105 and/or financial service system 110, and the identification number may comprise one of the data categories.

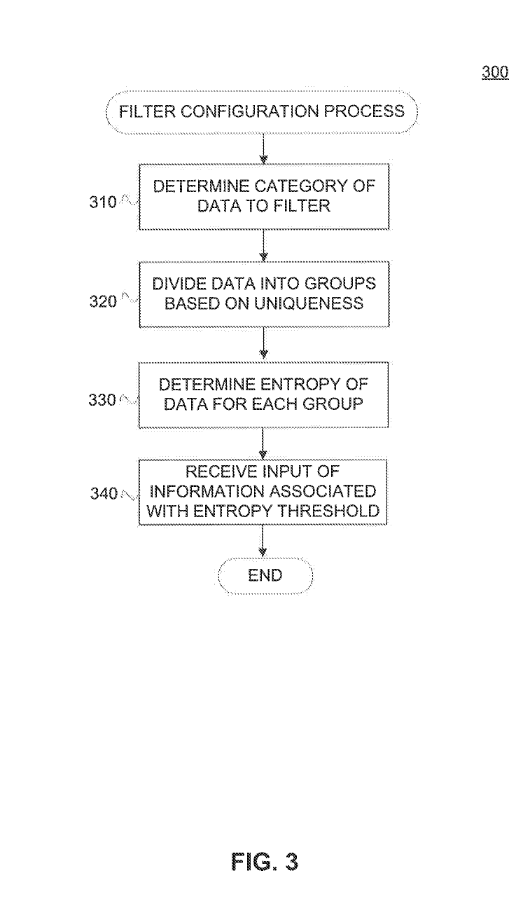

Financial service system 110 may perform a filter configuration process (Step 230). In some embodiments, financial service system 110 may determine one or more of the data categories determined in Step 220 to filter. Financial system 110 may further subdivide the chosen categories into groups based on the uniqueness of each individual piece of the data. For each of the groups, financial service system 110 may determine an entropy value for the data contained within the group. Finally, financial service system 110 may receive an input of information associated with a relative entropy threshold for each data type, or a single input for all data types, used to configure the depth of the filter. In some embodiments, the input may be a ratio, reflecting the relative entropy of a given group compared to the “unit” group of the particular category. For example, if a particular category of data (such as telephone number) uniquely identifies exactly one user 120 at Group #1, the ratio may be calculated as the group entropy for the given group divided by the Group #1 entropy value. This exemplary filter configuration process will be described in additional detail with respect to FIG. 3.

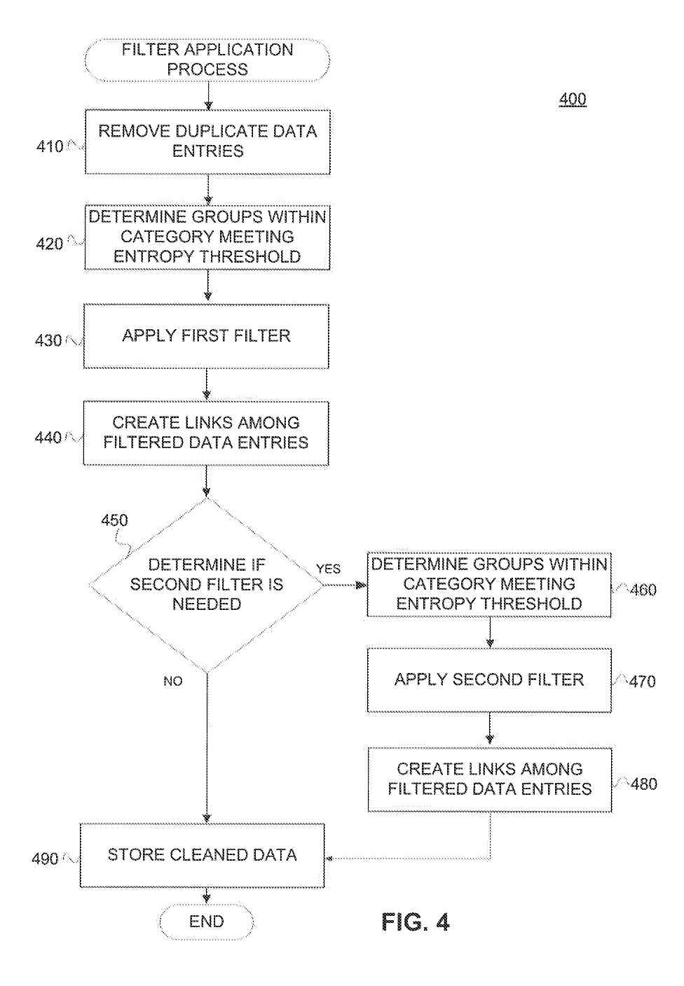

At step 240, financial service system 110 may perform a filter application process. In one embodiment, financial service system 110 may remove all data entries appearing more than a set number of times from the received data, as a preliminary filtering step. Based on the inputted threshold information received during one or more filter configuration processes, financial service system 110 may determine if one or more groups within the chosen data category meet or exceed the previously received entropy threshold ratio. As discussed previously, financial service system 110 may calculate one or more ratios between the entropy of each group and the entropy of the “uniquely identifying group,” i.e. the “Group #1” of each data category. The filter may then compare each of these individual ratios to the received entropy threshold ratio. Financial service system 110 may apply the first filter, removing all data entries that fail to meet the threshold criteria, and then may clean the dataset. In some embodiments, financial service system 110 may determine that a second round of filtering is desired or required for the particular dataset. In some embodiments, the second round of filtering may occur before links are generated between entries within the dataset. In other embodiments, the second round of filtering may occur after links are generated. In embodiments in which a second round of filtering is desired or required, system 110 may again determine groups within the chosen data category meeting an entropy threshold. In some embodiments, the relative entropy threshold value(s) for the second filtering step may be identical to the value(s) utilized in the first filter application; in other embodiments, a different relative entropy threshold value may be used for the second filtering. Financial service system 110 may then apply the second filter, if desired, and clean the dataset again. Finally, the cleaned data may be stored in one or both of memory 112 and/or database 135. This exemplary filter application process will be described in additional detail with respect to FIG. 4.

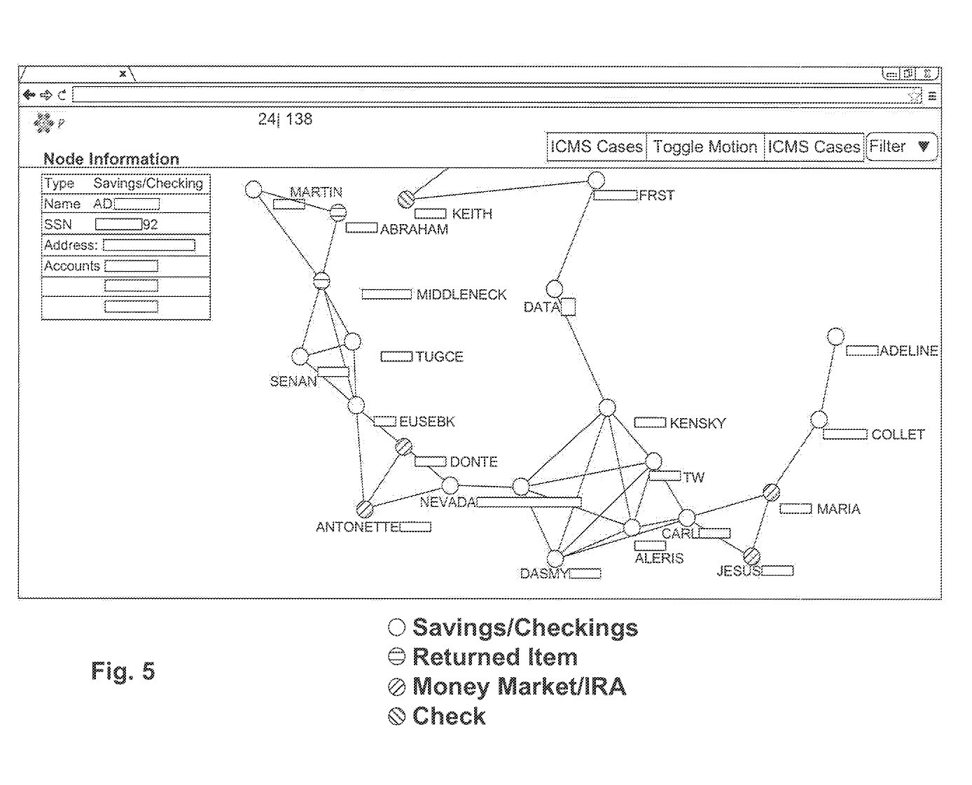

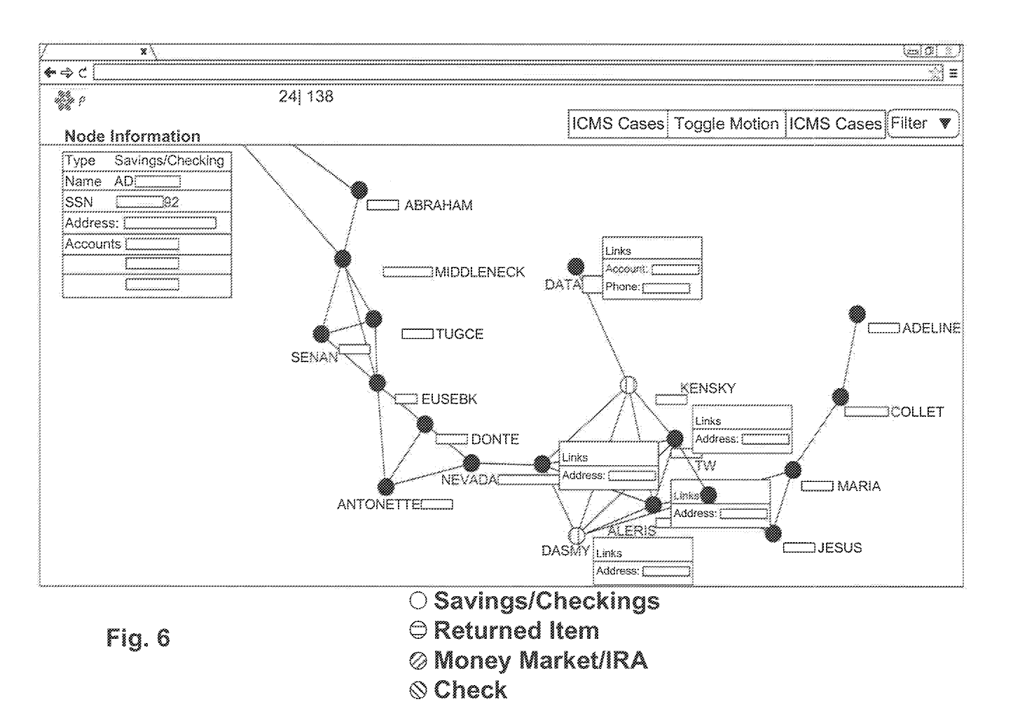

At Step 250, if confirmed links survive within one or more of the generated data networks after the one or more filtering steps, financial service system 110 may generate one or more illustrative representations of those networks. Exemplary network representations are illustrated below in association with FIGS. 5 and 6. In some embodiments, the illustrative representation may comprise a list of the links within the network. For example, it may be determined for a given instance of fraud that the victim can be linked to a plurality of users 120 who are working in concert, based on information deduced from the filtering. These individual users 120 may be placed on the network representation list, along with additional desired information, such as location, contact information, photographs, physical description, etc. More or less information may be placed on the illustrative representation list depending on predetermined criteria set by one or more of financial service system 110 and/or investigation system 130. In other embodiments, the filtered networks may be illustrated by financial service system 110 in a summary graphical representation. For example, the links in the network may be illustrated via a cloud diagram, a chart, or any other form of presentation capable of communicating information about the nature of the links to a trained or untrained observer, such as an individual associated with investigation system 130. Once generated, according to some embodiments, financial service system 110 may provide the illustrative network representations to another system to proceed with investigation of potential fraud, such as investigation system 130 (Step 260). The representations may be provided via transmission over network 140, i.e. through electronic mail communication, via a shared file system, or via direct access by investigation system 130 to a place where the representations and/or data are stored, such as memory 112 or database 135. Once investigation system 130 receives the network representations, they may be stored, for example in memory 132. Investigation system 130 may then perform various investigative and enforcement measures to identify, arrest, and prosecute perpetrators of financial fraud using information gleaned from the illustrative network representations.

FIG. 3 illustrates an exemplary filter configuration process 300, consistent with disclosed embodiments. Filter configuration process 300, as well as any or all of the individual steps therein, may be performed by any one or more of financial service system 110 or investigation system 130. For exemplary purposes, FIG. 3 is disclosed as being performed by financial service system 110.

Financial service system 110 may determine one or more of the previously determined categories of data to filter (Step 310). In some embodiments, the determination may be made with input from investigation system 130. In some embodiments, all categories of data may be filtered, either individually with a unique filter for each category of data, or simultaneously with a multi-faceted filter configured to filter each category of data at the same time. In some embodiments, financial service system 110 may determine a category selected from the group of name, address, or telephone number to filter, because those are common categories likely to lead to links between individuals. In some embodiments, financial service system 110 may define categories as a combination of data pieces, such as a “geographical name” category comprising the two categories “Name” and “ZIP code.” Any category or categories of data, however, may be chosen to filter based on system preferences or facts presented in a particular situation.

Within the chosen category of data, financial service system 110 may further divide the data into groups based on the uniqueness of the information contained in the data (Step 320). The groups within the categories may vary based on how much information is carried within the data. For example, a uniquely issued identification number, such as a federal social security number, driver's license number, or enterprise identification number associated with financial service provider 105 may identify as few as a single user 120, while a category such as “city of residence” may identify millions of users 120. In some embodiments, financial service system 110 may determine the groupings based upon how many unique users 120 are identified by each group. For example, if the chosen category is “phone number,” financial service system 110 may look at the entire dataset. A “Group #1” may comprise all phone number entries in the database that uniquely identify a single user 120. A “Group #2” may identify two customers, etc. Parameters and boundaries of groups are fluid and may vary based upon the chosen category of data, the size of the dataset, or other factors determined by financial service system 110 and/or investigation system 130. In some embodiments, the groups of data may be created based on the number of unique accounts the data identifies. In other embodiments, the groups of data may be created based on the number of households that a piece of data identifies. For instance, Group #1 within a particular category may comprise all phone numbers that uniquely identify households, while Group #2 may comprise phone numbers shared by exactly two households (households being identified preliminarily by financial service system 110). As discussed above, groups may also be created based on multiple categories of data simultaneously, such as names and particular ZIP codes. For example, a “John Smith” living in a ZIP code associated with New York City may be placed in a different group than a “John Smith” living in Cairo, based on the relative frequency of the name in different geographical regions.

Consistent with disclosed embodiments, financial service system 110 may apply an entropic filter configured to reduce noise and irrelevant data contained in a typical database, and increase the usefulness of automated linking. Financial service system 110 may automatically determine an entropy value of the data within each determined group within the chosen category of data (Step 330). Information theory can be used to help provide a quantitative measurement of how relevant a piece of data is, for example, via Shannon binary entropy. Such entropy for a set S is defined as below, where pᵢ represents the probability within the set S of picking randomly the information i:

H(G)=Σ_{i∈G}pᵢ·log₂(pᵢ);

wherein pᵢ may be inferred from the frequency count of each information pieces i. Note that in some embodiments where groups are based solely on counts, pᵢ=1/NG; wherein N_{G} is the number of unique pieces of information in set G.

Traditionally, an “entropy” measurement is used in the field of network architecture, to determine how many bits (and thus how much network bandwidth) would be needed to describe and transmit a given piece of data. Entropy can also be used in a data management context to tell a user how incisive a piece of data is. For example, if a single phone number links thousands of users 120 in a database, it is extremely likely that the number is incorrect and/or irrelevant. Conversely, a phone number linked to only a single user 120 is far more likely to be relevant and useful for informational purposes. Using the “phone number” example discussed previously, the highest entropy value would be assigned to “Group #1.” This group, which in this example comprises all phone numbers uniquely identifying a single user 120, possesses the most relevant, direct information. As each successive group becomes less and less exclusive (i.e. a phone number is associated with increasing numbers of users 120), the entropy value associated with each group also decreases.

Financial service system 110 may receive input of information associated with a desired relative entropy threshold (Step 340) for each data category. In some embodiments, one or more users associated with financial service provider 105 or investigation system 130 may determine an appropriate relative entropy threshold for each chosen category of data. The threshold may vary based on the type of information and based on known limitations of the data. For example, in the United States, where social security numbers are uniquely assigned to each individual, financial service system 110 may configure the entropic filter (by choosing the relative entropy threshold) such that the threshold for desirable data cuts any social security number with more than two instances from the database. Thus only “Group 1” and “Group 2” would survive when the filter is applied. Then, the relative entropy threshold value found could be applied, or serve as a good starting point, to filter other less obvious data categories, such as names. Conversely, data categories that are much more unique may have much more permissive entropy levels for the same relative entropy threshold. For example, for the same relative entropy threshold, if the chosen data category is user 120's name, few if any names may be cut at all, because a “Group #3” for names would still have a high level of entropy when compared to “Group #1” for names. The filter can be configured, however, to shape the dataset for categories such as “name” based on other circumstances or characteristics associated with the dataset. For example, the filter may be set up to remove all instances of a given piece of data over a certain number, and thus names may be filtered out in that manner. Therefore, even if the received entropy threshold information would not disqualify a name such as “John Smith,” the ninth instance of John Smith within, say, a single zip code could be a cutting point based on the filter configuration. Thus, geography may play a role as well—if a relatively unique name appears too frequently in a small geographic area, the filter may be configured to detect that the data is useless and cut in that geographical area all of the instances of the particular name if the count passes a certain number. For example, if “John Smith” is again the subject of the filter, but the area being screened is an area in Southeast Asia, the filter parameters may be configured differently than if the filter is asked to screen users 120 located in Washington, DC. Such nuances in the filter may also be configured by applying the entropic filter twice, which will be discussed below.

FIG. 4 illustrates an exemplary filter application process 400, consistent with disclosed embodiments. Filter application process 400, as well as any or all of the individual steps therein, may be performed by any one or more of financial service system 110 or investigation system 130. For exemplary purposes, FIG. 4 is disclosed as being performed by financial service system 110.

Financial service system 110 may initially clean the dataset by removing duplicate data entries (Step 410). As discussed above, in some embodiments, users associated with financial service provider 105 or investigation system 130 may determine that, as a preliminary filter, all pieces of data appearing in the dataset ore than a set number of times should be removed automatically before the actual entropic filter is applied. Such a determination may be useful, for example, in particularly large datasets or particularly small datasets. In some embodiments, duplicate data entries may be removed only if all categories of data are identical. In other embodiments, data entries that are duplicates in selected categories may be removed, or alternatively, set aside for further subsequent review and analysis by investigation system 130, including manual review. For example, as discussed above, data entries in which more than one user 120 shares a social security number may be either removed or set aside. In some alternative embodiments, the duplicate data removal step may not be performed, and the entropic filter may be configured in a filter configuration process such as process 300 to automatically remove the duplicate entries when the filter is applied.

In some embodiments, in order to accommodate disambiguation via “fuzzy matching,” data fields might be simplified prior to filtering. For example, vowels and spaces may be removed from names prior to processing. In such an embodiment, “Jahn Smith” and “John Smith” would both be attributed to the similar string “JhnSmth.” Fuzzy matching as illustrated in this example helps enhance the relevance of collected data by reducing the impact spelling mistakes or other mistakes related to mistranslation, improper data entry, etc. In some embodiments, fuzzy matching may be performed on a dataset before links are generated between the data entries. In other embodiments, the fuzzy matching may be performed after the links are generated, and the links may be checked thereafter. In still other embodiments, fuzzy matching may be performed both before and after link generation to maximize the value of the collected dataset.

Based on the parameters determined during one or more prior filter configuration processes, such as filter configuration process 300, financial service system 110 may determine a subset of one or more groups within the chosen category of data that meet a predetermined entropy threshold (Step 420). As discussed above, in some embodiments each individual category of data may have a different relative entropy threshold. As a result, a data entry that might “survive” one application of the entropic filter based on filtering of one chosen category of data might be removed in another application of the entropic filter based on another chosen category. As a result, the remaining data entries are likely to all be relevant and informative. The relative entropy threshold may be set as a percentage or multiplier of the entropy of “Group 1,” or the most unique group. The entropy values themselves are unit-less, so the values as compared between groups of data may be relative to one another. For example, the entropy value of “Group 1” might be 15. Based on the inputted entropy threshold information received during the filter configuration process, financial service system 110 may cut any groups in the chosen category of data that have less than 50% of the entropy of Group 1. By extension, this would mean that that data also has less than 50% of the relevance, informative value, and likelihood of assisting investigation system 130 in pursuing individual cases of fraud. In the example discussed above, financial service system 110 would thus remove all data entries in groups with an entropy value less than 7.5. In some embodiments in which the data is filtered based on multiple chosen categories of data, multiple relative entropy thresholds may be employed simultaneously. For example, if a data set is to be filtered based on the chosen categories of “name” and “address,” the “name” category is likely to have more entropy since names are more unique than addresses, especially in dense urban environments. Therefore, “Group 1” of the name category might have an entropy value of 50, and any groups with an entropy value less than 25 might be targeted for removal, yielding a relative threshold of 0.5. On the other hand, “Group 1” of the address category might have an entropy value of 20, and the relative entropy threshold may be adjusted from 0.5 down to 0.25 so that more data is kept, i.e. only groups with an entropy value of less than 5 are targeted for removal.

Financial service system 110 may apply a first configured filter to the dataset (Step 430). In some embodiments, the filtering algorithm may be comprised of SQL code. In other embodiments, the filter may be contained within a database or a graph database. In some embodiments, the filter may be written as Python or Java code, or in any other machine-readable programming language. Alternatively, the filter may be written and applied as one or more formulas or field parameters within a spreadsheet program, such as Excel®. In still other embodiments, the filtering algorithm may be a combination of these code sources. Based on the configured parameters of the first filter, financial service system 110 may first remove duplicate data entries, then may remove any data entries that failed to meet the configured entropy threshold(s). The filtering may be performed automatically. In some embodiments, data entries that the filter designates for removal may be deleted permanently. In other embodiments, the data entries that are “removed” may not be permanently deleted, but may be cut from the dataset and stored separately in a storage device such as database 135, memory 112, or memory 132. In still other embodiments, the “removed” data entries may not be physically removed from the dataset at all, but may be somehow annotated within the system to not be included when linkages are made between surviving data entries. Any method of cleaning the dataset may be employed by financial service system 110, so long as the data deemed irrelevant based on the configuration of the filter is prevented from becoming part of the network(s) of data that will be provided to investigation system 130 for further analysis.

Financial service system 110 may create links among the remaining cleaned data entries after applying the first filter (Step 440). Links may be created by matching data fields with each other. For instance, if two customers share a phone number that made it through the filter, financial service system 110 may generate a “link” between those two customers. Data fields can be matched exactly, or be matched as discussed above using “fuzzy matching” on strings and numbers, allowing for spelling or data entry mistakes. As described above in association with Step 410, in some embodiments fields of data may be pre-processed before applying the filter to accommodate fuzzy matching, in which case matching will be done on the pre-processed fuzzy fields (e.g. matching the fuzzy version of the string “JhnSmth”). In other embodiments, fuzzy matching techniques may be applied after filtering is complete. As discussed above, filtering the dataset consistent with the disclosed embodiments may help uncover and identify instances of organized fraud that would not otherwise be detected by manual review. By automating the data analysis process and culling massive datasets such that they contain only the most relevant information, the utility and accuracy of a network may be improved. Financial service system 110 may be configured to create or suggest links between data entries that have been cleaned by the entropic filter. For example, individuals sharing an address, a telephone number, a financial service account number, frequent purchase transactions at the same merchant, etc. may be linked by the system. Whether or not a link is made by the system may be impacted by various factors. For example, two individuals sharing an address may be particularly significant if the address is a single family home or a single apartment. When the shared address is a large office building or a large multi-family residential structure with no additional unit delineation, the shared address is less informative. Such differences may be accounted for during the application of the filter itself, either through entropy threshold determination or through de-duplication of data. As discussed above in association with entropic link filtering process 200, financial service system 110 may generate various summary illustrative representations of the links created within the dataset, and present them to investigation system 130 for further investigation and analysis.

In some embodiments, financial service system 110 may determine if a second filtering step is desired or required for the particular dataset under analysis (Step 450). A second filter application may be desirable in various situations. For example, if a dataset is smaller than average, there may be increased noise within the data and it may be difficult to achieve statistical significance from the dataset. A second pass of an entropic filter consistent with disclosed embodiments may assist in creation of a cleaner, more usable dataset in these cases. In other embodiments, a second filtering step may be desirable in order to isolate specific desired data, or to account for unique characteristics of a dataset. For example, if a geographic enclave of a particular ethnic, national, or cultural group is situated in a small area within a city, the concentration of individual users 120 with the same name might be increased over what would typically be expected. Additional filtering can account for such abnormalities.

If any of financial service provider 105, financial service system 110, or investigation system 130 determine that a second filtering step is necessary (Step 450: YES), then a second filter is applied in a manner that may be substantially similar to the steps described above. Financial service system 110 may determine a subset of one or more groups within the chosen category of data that meet a predetermined entropy threshold (Step 460). This determination step is similar to that described above in association with Step 420. In some embodiments, financial service system 110 may apply the same entropy threshold parameters as were applied with the first filter. In other embodiments, system 110 may determine that either looser or stricter thresholds may be required for he second filtering in order to achieve the desired utility within the dataset.

Financial service system 110 may apply the second configured filter to the dataset (Step 470). As discussed above in association with the first filtering of Step 430, the filtering may be performed automatically, and may comprise SQL code, spreadsheet formulas, or a combination thereof. As before, data that is filtered out by the application of the second filter may be deleted permanently, may be stored in an alternative location within a storage device, such as memories 112 or 132 or database 135, or may be kept in the dataset but annotated in a manner that does not permit inclusion in further analysis.

Financial service system 110 may create links among the remaining cleaned data entries after applying the second filter (Step 480). In some embodiments, links created during the application of the first filter (as in Step 440, above) may be maintained during application of the second filter, and may be kept or broken by the configuration of the second filter. In other embodiments, financial service system 110 may disregard any or all links created in the first filter application, may apply the second filter, and then create new links based on the results of the second filtering. The links created may then be the same as those created after the first filter, or may be different based on the further cleaning of the dataset performed by application of the second filter. After application of the second filter, or if a second filtering was deemed unnecessary (Step 450: NO), financial service system 110 may store the cleaned, filtered dataset for purposes of further analysis, such as investigation by investigation system 130 (Step 490). The filtered dataset may be stored in database 135, such that it can be accessed via network 140 by any member systems of system environment 100, and/or it may be stored within constituent storage units associated with the individual systems, such as memory 112 or memory 132.

FIGS. 5 and 6 illustrate exemplary graphical representations of networks generated by the disclosed embodiments. In the exemplary network representation illustrated in FIG. 5, circular “nodes” represent customers and may be color-coded or otherwise labeled in a distinguishable manner to reflect the objects assigned to them (e.g., savings accounts, checking accounts, loans, fraud cases, etc.). In the top right corner of the exemplary interface shown in FIG. 5, the interface allows a user, such as a user associated with investigation system 130, to choose whether or not to apply an additional filter and select or de-select particular types of links. For example, the user may choose to only display links based on “phone number” and ignore links based on “check payee name” categories.

FIG. 6 illustrates an exemplary “risk assessment” view of the network illustrated in FIG. 5 that may be utilized by an entity, such as financial service system 110 or investigation system 130, to further investigate and pursue links that pose a risk or threat of fraud. The nodes highlighted with vertical stripes in FIG. 6 indicate customers associated with fraud cases, charge-offs, returned items, or any other behaviors that may indicate possible criminal activity. The left pane of the exemplary user interface displays data associated with each node (such as type of accounts, customer information, amount of losses for a fraud case, etc.).

In the example illustrated in FIG. 6, nodes corresponding to users “KENSKY” and “DASMY” have been highlighted with vertical stripes, indicating that information exists associating them with criminal activity. In some embodiments, this criminal activity may have been committed against financial service system 110, or against one or more customers or accounts associated with financial service system 110. Using the network links contained in the graphical representation of FIG. 6, financial service system 110 and/or investigation system 130 may identify one or more common links for a particular instance of criminal activity. In the illustrated example, KENSKY and DASMY share common links to four other nodes, including “ALERIS,” “CARL,” and “TW” from FIG. 5. In the graphical user representation of FIG. 6, the system has identified that these four nodes share a common address with KENSKY and DASMY, which may indicate an organized fraud scheme or other such concerted criminal effort. Using this information, investigation system 130 may perform one or more additional investigational or enforcement-related actions associated with the particular criminal activity displayed in the “risk assessment” mode shown in FIG. 6.

Various entities, such as financial service system 110 and/or investigation system 130, may utilize one or more network representations such as those illustrated in the examples of FIGS. 5 and 6 to more rapidly and accurately identify instances of potential fraud, and act on them. The automated entropic filter(s) described above in association with FIGS. 2-4 enhance the utility and value of the network representations, by automatically removing noise and irrelevant data. Previous systems required enormous investments of manpower and time to manually sort through datasets to cull out duplicates, misspellings, and meaningless entries. Reducing the time needed to detect potential fraud substantially increases the chances that the perpetrators can be identified and investigated. The disclosed embodiments may thus limit damages and exposure to risk of both financial service providers, such as financial service provider 105, as well as individual customers, such as user 120.

Other features and functionalities of the described embodiments are possible. For example, the processes of FIGS. 2-4 are not limited to the sequences described above. Variations of these sequences, such as the removal and/or the addition of other process steps may be implemented without departing from the spirit and scope of the disclosed embodiments.

Additionally, the disclosed embodiments may be applied to different types of data analysis. Any financial service institution that provides financial service accounts to customers may employ systems, methods, and articles of manufacture consistent with certain principles related to the disclosed embodiments. In addition, any governmental entity, law enforcement entity, political entity, or educational entity may also employ systems, methods, and articles of manufacture consistent with certain disclosed embodiments.

Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but are instead defined by the appended claims in light of their full scope of equivalents.

What is claimed is:

1. A system for automatically generating links between entries of a dataset, the system comprising:
a memory storing instructions; and
a processor configured to execute the instructions to:
receive data associated with a plurality of financial service accounts;
determine a first subset of the data;
determine a plurality of groupings within the first subset based on uniqueness of the data;
determine an entropy value for each of the plurality of determined groupings;
determine whether one or more of the entropy values associated with the determined groupings are less than a first threshold entropy value for the first subset;
remove the determined groupings whose entropy values are less than the first threshold entropy value for the first subset from the data;
generate a network of links within the remaining data based on predetermined criteria; and
generate at least one summary representation of the links.

2. The system of claim 1, wherein the processor is further configured to execute the instructions to:
determine whether one or more of the entropy values associated with the determined groupings are less than a second threshold entropy value; and
remove the determined groupings whose entropy values are less than the second threshold entropy value from the data.

3. The system of claim 2, wherein the first and second entropy values are equal.

4. The system of claim 1, wherein removing the determined groupings whose entropy values are less than the first threshold entropy value from the data comprises permanently deleting the groupings from the data.

5. The system of claim 1, wherein removing the determined groupings whose entropy values are less than the first threshold entropy value from the data comprises flagging the groupings from the data such that the determined groupings are excluded from the generated network of links.

6. The system of claim 1, wherein the first subset of the data is selected from a group comprising name, address, or telephone number.

7. The system of claim 1, wherein the processor is further configured to execute the instructions to:
determine a second subset of the data;
determine a plurality of groupings within the second subset based on uniqueness of the data;
determine an entropy value for each of the plurality of determined groupings;
determine whether one or more of the entropy values associated with the determined groupings are less than the first threshold entropy value for the second subset; and
remove the determined groupings whose entropy values are less than the first threshold entropy value for the second subset from the data.

8. The system of claim 7, wherein the first threshold entropy value for the first subset and the first threshold entropy value for the second subset are different values.

9. The system of claim 1, wherein the processor is further configured to execute the instructions to remove duplicate instances of data from the determined groupings.

10. The system of claim 1, wherein the processor is further configured to provide the generated summary representations of the links within the network to a second system for further investigation.

11. A method for automatically generating links between entries of a dataset, the method comprising:
receiving data associated with a plurality of financial service accounts;
determining a first subset of the data;
determining a plurality of groupings within the first subset based on uniqueness of the data;
determining, via one or more processors, an entropy value for each of the plurality of determined groupings;
determining, via the one or more processors, whether one or more of the entropy values associated with the determined groupings are less than a first threshold entropy value for the first subset;
removing, via the one or more processors, the determined groupings whose entropy values are less than the first threshold entropy value for the first subset from the data;
generating, via the one or more processors, a network of links within the remaining data based on predetermined criteria; and
generating at least one summary representation of the links.

12. The method of claim 11, further comprising:
determining whether one or more of the entropy values associated with the determined groupings are less than a second threshold entropy value; and
removing the determined groupings whose entropy values are less than the second threshold entropy value from the data.

13. The method of claim 11, wherein removing the determined groupings whose entropy values are less than the first threshold entropy value from the data comprises permanently deleting the groupings from the data.

14. The method of claim 11, wherein removing the determined groupings whose entropy values are less than the first threshold entropy value from the data comprises flagging the groupings from the data such that the determined groupings are excluded from the generated network of links.

15. The method of claim 11, wherein the first subset of the data is selected from a group comprising name, address, or telephone number,

16. The method of claim 11, further comprising:
determining a second subset of the data;
determining a plurality of groupings within the second subset based on uniqueness of the data;
determining an entropy value for each of the plurality of determined groupings;
determining whether one or more of the entropy values associated with the determined groupings are less than the first threshold entropy value for the second subset; and
removing the determined groupings whose entropy values are less than the first threshold entropy value for the second subset from the data.

17. The method of claim 16, wherein the first threshold entropy value for the first subset and the first threshold entropy value for the second subset are different values.

18. The method of claim 11, further comprising removing duplicate instances of data from the determined groupings.

19. The method of claim 11, further comprising providing the generated summary representations of the links within the network to a second system for further investigation.

20. A system for detecting fraud, the system comprising:
a memory storing instructions; and
a processor configured to execute the instructions to:
receive information from a second system associated with automatically generated data networks, the information being received in the form of one or more graphical representations of the automatically generated data networks;
analyze the received information; and
perform at least one additional action based off of the analysis, the at least one additional action comprising at least one of investigating an individual based on the received information, applying an additional filter to the received information, or performing an enforcement action.
